(19) United States
(12) Patent Application Publication
(10) Pub. No.: US 2016/0028242 A1
(43) Pub. Date: Jan. 28, 2016

(54) PRIMARY-SIDE COIL ASSEMBLY FOR INDUCTIVE ENERGY TRANSFER USING QUADRUPOLES

(71) Applicant: PAUL VAHLE GMBH & CO. KG, Kamen (DE)

(72) Inventors: Faical TURKI, Bergkamen (DE); Jürgen MEINS, Braunschweig (DE)

(21) Appl. No.: 14/775,524

(22) PCT Filed: Dec. 6, 2013
(86) PCT No.: PCT/EP2013/075814

§ 371 Date: Sep. 11, 2015

(30) Foreign Application Priority Data
Mar. 12, 2013 (DE) 10 2013 004 180.5

(51) Int. Cl. H02J 5/00; H01F 38/14

(52) U.S. Cl. CPC H02J 5/005; H01F 38/14

(57) ABSTRACT

The invention relates to a primary-side coil assembly for an inductive energy transfer system for transferring energy between a primary- and a secondary-side coil assembly (A₁, A₂). The invention is characterised in that the primary-side coil assembly (A₁) has four coils (_{z}, SP₃, SP₄) which form the four adjacent coil regions (BE_{P1}, BE_{P2}, BE_{P3}, BE_{P4}) of the coil assembly (A₁), the phase position (ΦIᵢ) of the coil fluxes (SP₁, SP₂, SP₃, SP₄) in relation to one another flowing through the coils (I₁, I₂, I₃, I₄) determining the phase position (φBᵢ) of the magnetic flux density (Bᵢ) which is established in the regions (BE_{P1}, BE_{P2}, BE_{P3}, BE_{P4}). With the use of a secondary-side coil assembly (A₂) comprising four adjacent coil regions (BEₛ₁, Beₛ₂, BEₛ₃, BEₛ₄), the phase position (ΦIᵢ;) of the coil fluxes (I₁, I₂, I₃, I₄) is established such that in the four regions (BE_{P1}, BE_{P2}, BE_{P3}, BE_{P4}) of the primary-side coil assembly (A₁), the phase position (ΦBᵢ) of the respective magnetic flux densities (Bᵢ) which are established is 0°, 90°, 180° and 270° in relation to one another.

The present invention relates to a primary-side coil assembly for an inductive energy transfer system for transferring energy between a primary- and a secondary-side coil assembly.

Primary coil assemblies for inductive energy transfer systems are widely known. Simple circular, planar coils or two planar, rectangular coils are used for energy transfer on the primary side.

The disadvantage of the known primary-side coil assemblies is that the power density is often not high enough or, based on the coil assembly selected, this only interacts with a satisfactory degree of efficiency with a specific coil assembly on the secondary side.

The object of the present invention is to provide a primary-side coil assembly having a power density that is as high as possible and also, if necessary, is compatible with various secondary-side coil assemblies.

This task is achieved as per the invention with a coil assembly according to claim 1, 2 or 3. The invention is based on the general idea that the magnetic fluxes generated with the four coil regions in their phase position in relation to each other can be determined by the phase position of the coil currents in relation to each other, and consequently depending on the use of a specific or several secondary-side coil assembly types, a maximum power density can be achieved. The invention also includes embodiments, however, in which the primary-side assembly is only ever operated with a specific secondary-side coil assembly type, wherein an automatic adjustment for other secondary-side coil assembly types then no longer needs to be made. In this case, the currents must be permanently established or adjusted such that the respectively required phase positions of the magnetic flux are established in relation to each other in the coil regions of the primary-side coil assembly.

It is particularly advantageous if the primary-side assembly detects the secondary-side coil assembly type and can then establish or adjust the phase position of the coil currents accordingly. This can take place through communication between the primary- and secondary-side assemblies. It is also possible, however, that the primary-side assembly detects the secondary-side coil assembly type based on the coupling. Consequently, the primary-side control device can change the phase position of the magnetic fluxes in the coil regions of the primary-side coil assembly between several modes and define the coupling for each mode, wherein the best coupling determines the mode to be selected for the energy transfer.

In the simplest case, the four coil regions according to the invention are formed respectively by individual and, where possible, non-overlapping planar coils. A substantially higher power density can be achieved, however, if overlapping primary-side coils are used, which form the four coil regions, wherein two coils respectively encircle a coil region at least on three sides. Consequently, the four coil regions can be advantageously formed from four rectangular coils, wherein the longer sides of two rectangular coils are arranged next to each other and together respectively form a split pair coil. Both split pair coils are turned 90° in relation to each other and arranged above each other. This advantageous assembly produces a mechanical and electrical decoupling of the coils which results in magnetically decoupled circuits and higher power density due to better utilisation of the ferrite.

The two-phase coil system spatially and temporally staggered by 90° generates a spatially rotating two-pole field distribution.

The coil regions can also be described as magnetic poles since they are characterised by the fact that the magnetic flux has the same phase position everywhere inside a coil region.

If a secondary coil assembly consisting of an individual, circular secondary coil is used, the external outline of which can correspond to the shape and size of that of the primary-side coil assembly with four coil regions, then the magnetic fluxes in the four coil regions must be identical in terms of their phase position. This operating mode can also be referred to as the first mode.

If a secondary coil assembly consisting of two individual, rectangular secondary coils arranged next to each other is used, the overall external outline of which corresponds to the shape and size of the primary-side coil assembly with four coil regions, then the coil regions of the primary coil assembly respectively assigned to a secondary-side coil must respectively generate in phase magnetic fluxes. The phase position of the magnetic fluxes of the primary-side coil regions, which are assigned to different secondary-side coils, is 180° in relation to each other. This operating mode can also be referred to as the second mode.

If a secondary-side coil assembly is used, however, which, like the primary-side coil assembly, also has four coil regions, the four primary-side coil regions should generate magnetic fluxes, whose phase positions correspond to 0°, 90°, 180° and 270°. This operating mode can also be referred to as the third mode.

The coils in the coil assemblies together with capacities respectively form parallel or series resonant circuits. If series resonant circuits are used, the coils of a split pair coil can be advantageously connected in series.

The primary-side coil assembly according to the invention can consist of individual coils, advantageously four overlapping, planar windings, which are arranged parallel to a ferrite core and together with the latter form the coils and coil regions. The coil regions can be configured as square, rectangular, part circle shape (pie slice) or triangular, wherein each coil region is arranged in a quadrant of a right-angled coordinate system. Ultimately, the shape of each coil region inside a square can be configured arbitrarily. Consequently, the primary-side coil assembly can have a rectangular, in particular square, round, in particular circular or elliptical external outline. The same applies to the secondary-side coil assembly.

The planar windings must be configured in accordance with the shape of the required coil regions, such that they enclose or encircle two coil regions. Here a coil can encircle two coil regions arranged in adjacent or diagonally opposite quadrants, wherein the overlapping coils are arranged at right angles in relation to each other.

Furthermore, it is possible that at least one other coil is arranged parallel to the coil assembly with four coil regions described above, which can generate its own magnetically decoupled magnetic field. Improved coupling with a horizontal offset between the primary-side and secondary-side coil assembly can be achieved as a result.

As with all inductive energy transfer systems, the coils in the coil assembly, together with at least one capacitor, form resonant circuits. The primary-side resonant circuits are supplied by at least one controlled inverter.

It has proven advantageous if the coils of a previously described split pair coil are respectively connected in series, wherein a centre tap impedance is electrically connected with one terminal to the point of connection of both the coils of a split coil pair connected in series and with the other terminal to the midpoint/centre tap, positive or negative terminal of the intermediate circuit of the inverter.

An inductive energy transfer system having a primary coil assembly according to the invention is also claimed. The secondary coil assembly can be configured as described above.

The secondary coil assembly can also be configured in exactly the same way as the primary coil assembly, wherein only one rectifier circuit then needs to be connected downstream.

The invention is explained in greater detail below using drawings:

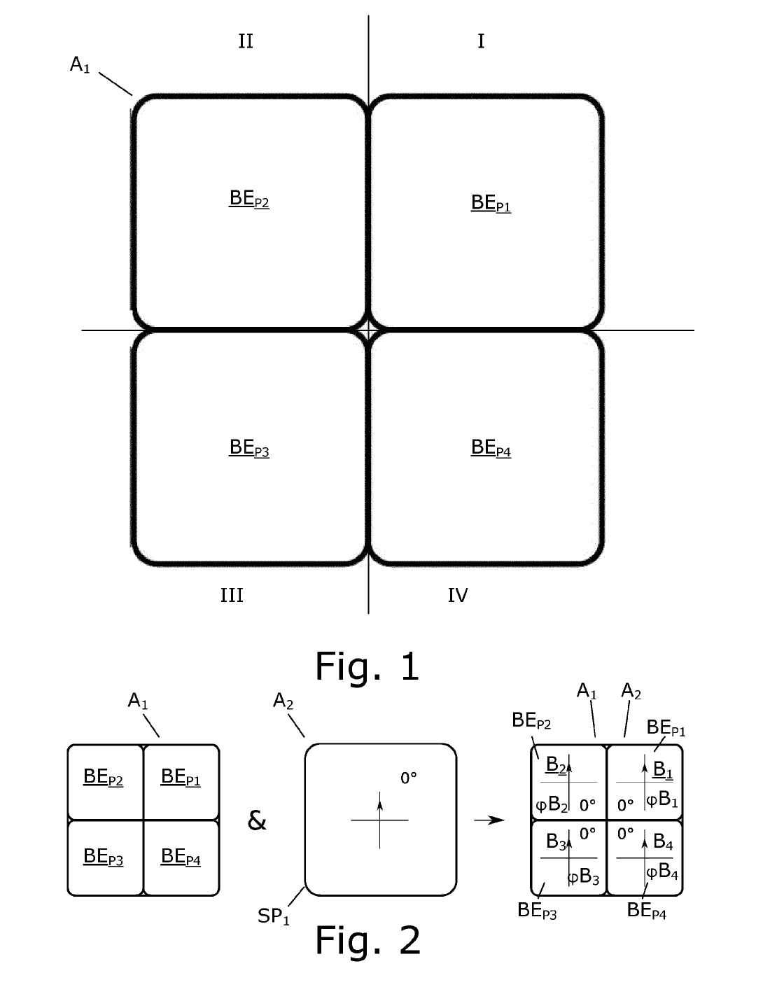

FIG. 1 shows a coil assembly according to the invention with four coil regions lying in a plane;

FIG. 2 shows a primary coil assembly with four coil regions interacting with a secondary circular coil assembly;

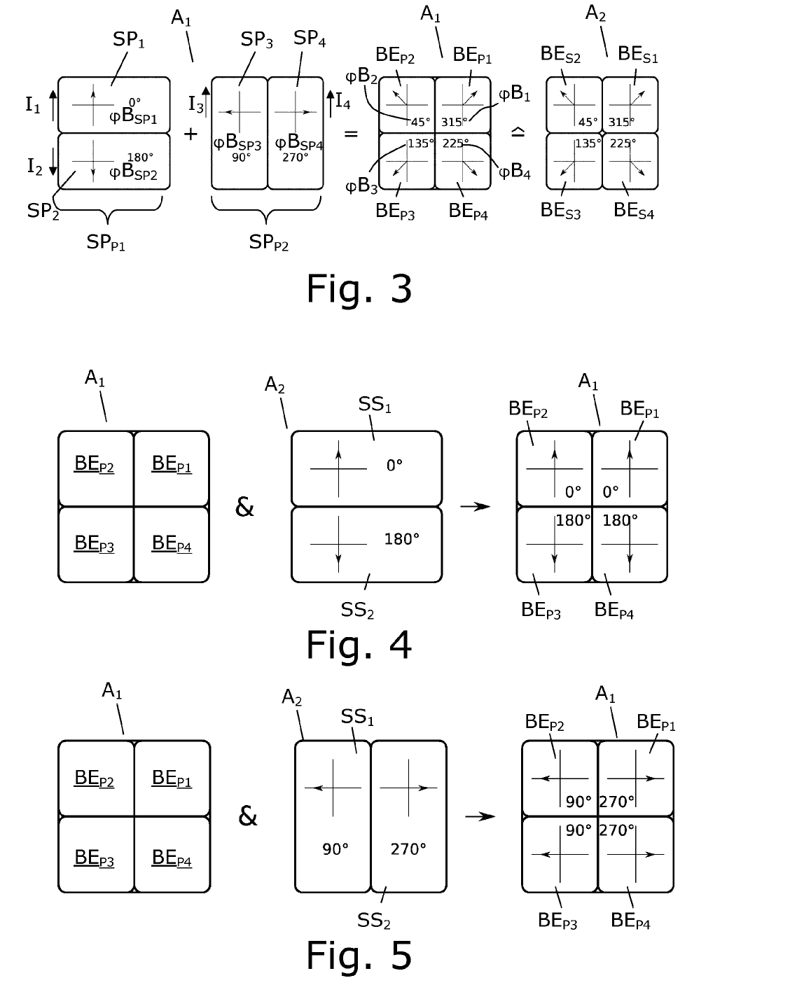

FIG. 3 shows a primary coil assembly consisting of four rectangular coils;

FIGS. 4 and 5 show a primary coil assembly with four coil regions interacting with a secondary coil assembly consisting of two rectangular coils;

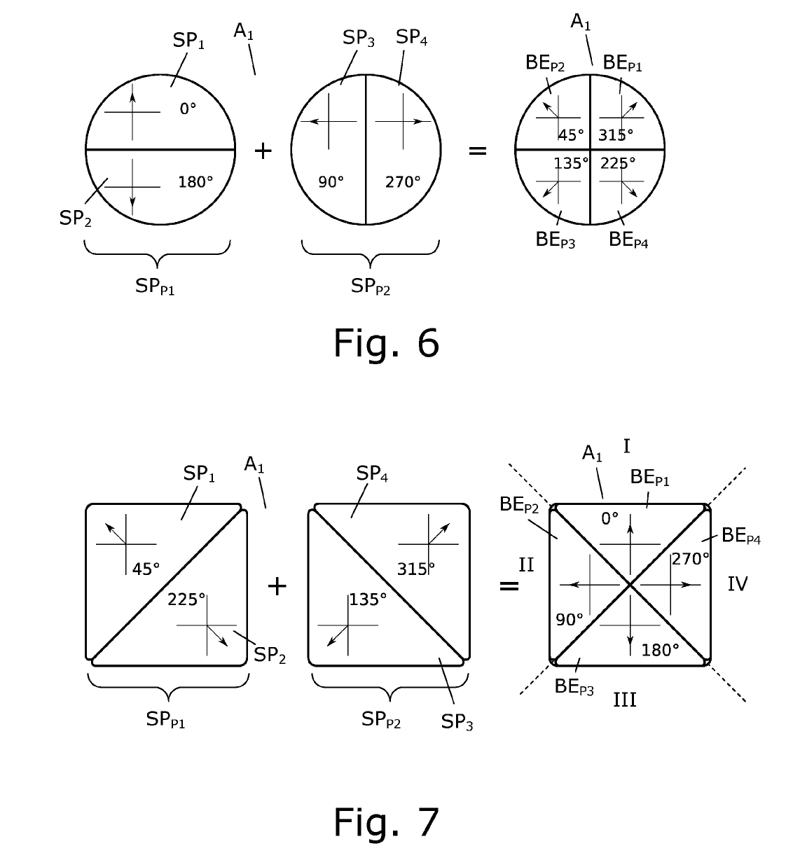

FIG. 6 shows a primary coil assembly consisting of four semi-circular overlapping coils;

FIG. 7 shows a primary coil assembly consisting of four triangular overlapping coils;

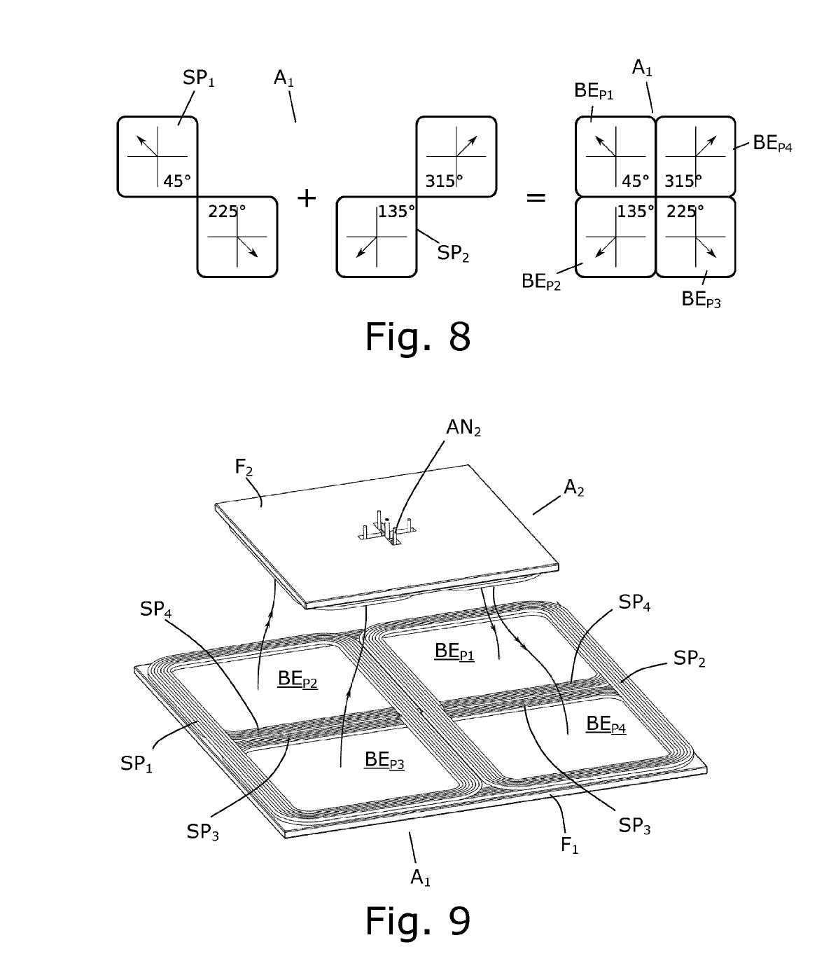

FIG. 8 shows a special shape of a primary coil assembly consisting of two coils forming a figure of eight, which are arranged at right angles to each other and form four coil regions;

FIG. 9 shows an inductive energy transfer device with a primary-side and a secondary-side coil assembly;

FIG. 10 shows a possible embodiment of the primary coil assembly as a solenoid;

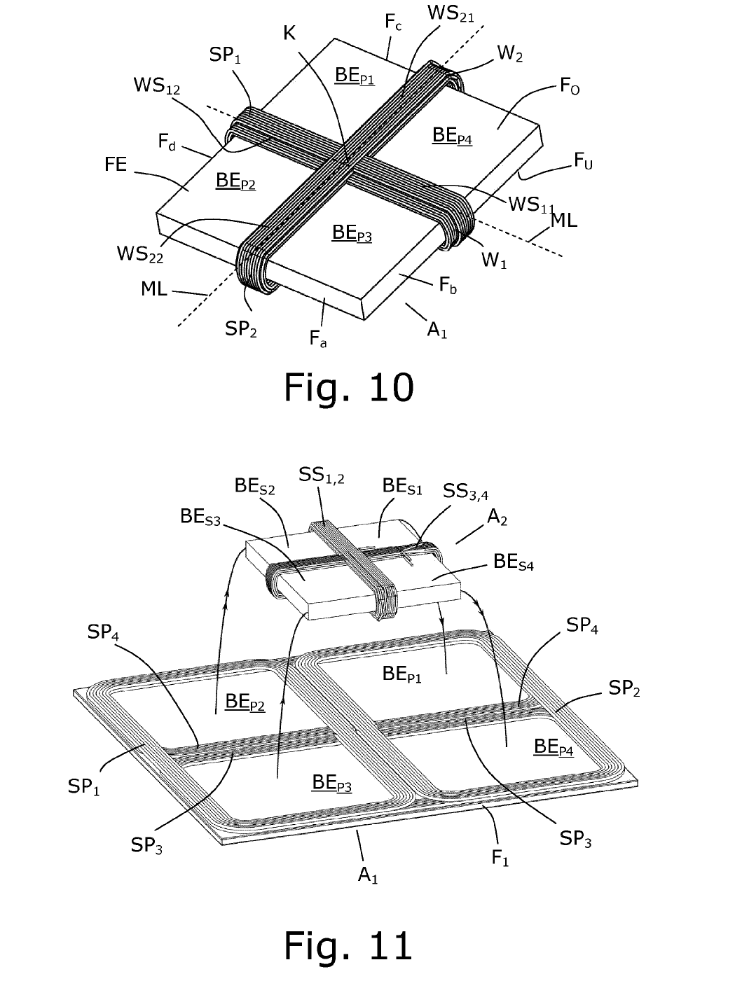

FIG. 11 shows a primary coil assembly according to FIG. 9 with a secondary solenoid coil assembly;

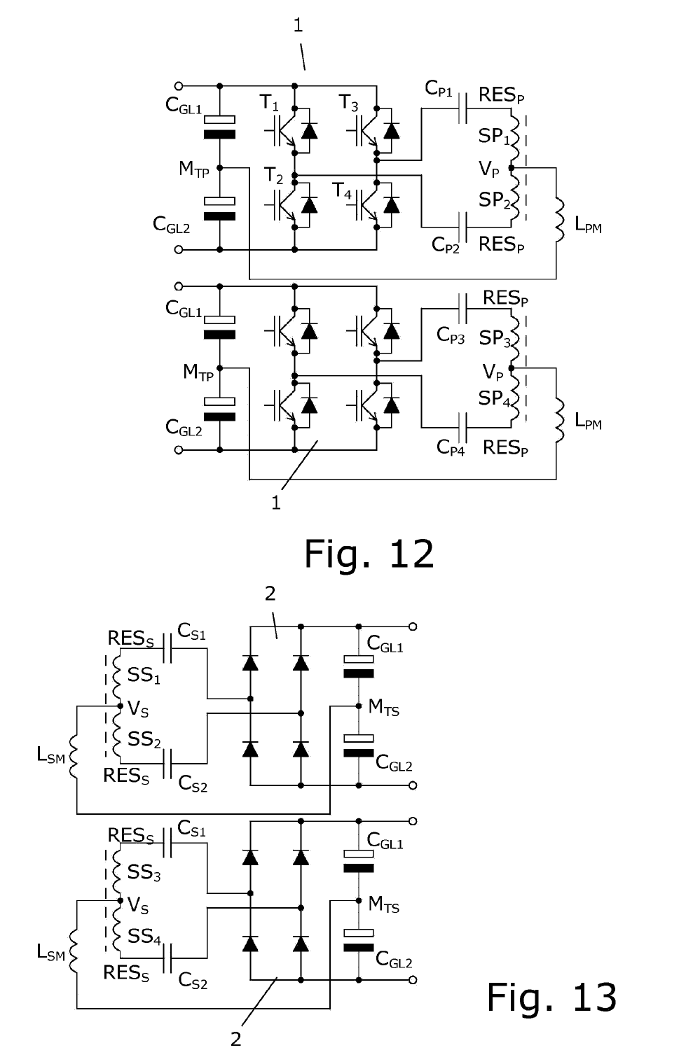

FIG. 12 shows a circuit for the primary side of an inductive energy transfer system;

FIG. 13 shows a circuit for the secondary side of an inductive energy transfer system.

FIG. 1 shows a coil assembly A₁ according to the invention with four coil regions BE_{P1}, BE_{P2}, BE_{P3} and BE_{P4} lying in a plane. The coil regions BE_{P1}, BE_{P2}, BE_{P3} and BE_{P4} are arranged in quadrants I to IV for a better understanding of the invention. Naturally, the individual coil regions BE_{P1}, BE_{P2}, BE_{P3} and BE_{P4} can also have different shapes and sizes. The coil regions BE_{P1}, BE_{P2}, BE_{P3} and BE_{P4} are spanned by coils, which are not shown in FIG. 1, since the coil shapes and number of coils can be configured differently.

Depending on the type of secondary-side coil assembly A₂ used, the phase position of the magnetic fluxes in the individual coil regions BE_{P1}, BE_{P2}, BE_{P3} and BE_{P4} can be established. The phase positions in the individual coil regions BE_{P1}, BE_{P2}, BE_{P3} and BE_{P4} of the primary-side coil assembly A₁ can be predefined as long as only one secondary-side coil assembly type is employed or used. As soon as interoperability is required, i.e. energy is to be supplied to differently configured secondary-side coil assemblies A₂ by means of the primary-side coil assembly A₁, it must be possible to change the phase positions of the magnetic fluxes in the primary-side coil regions BE_{P1}, BE_{P2}, BE_{P3} and BE_{P4} in relation to each other.

FIG. 2 shows a primary-side coil assembly A₁ according to the invention with four coil regions BE_{P1}, BE_{P2}, BE_{P3} and BE_{P4} interacting with a secondary coil assembly A₂ having a circular coil SP_{S1}. The coil assemblies A₁ and A₂ preferably have the same external outlines. It is possible, however, that the shape and size of the coil assemblies A₁ and A₂ differ from each other. In order to be able to transfer energy from the coil assembly A₁ to the secondary-side coil assembly A₂ with maximum efficiency, the phase positions ΦBᵢ of the magnetic flux densities B₁ to B₄ must be the same in the individual coil regions BE_{P1}, BE_{P2}, BE_{P3} and BE_{P4} as shown in FIG. 2, i.e. the phase differential between all coil regions is 0°.

FIG. 3 shows a primary coil assembly A₁ consisting of four rectangular coils SP₁ to SP₄. The coils SR₁ and SP₂ form a first split pair coil SP_{P1} and the coils SP₃ and SP₄ form a second split pair coil SP_{P2}. The phase position φI₁ of the current I₁ flowing through the coil SP₁ is selected such that a magnetic flux B_{SP1} with a phase position φB_{SP1} of 0° is established in the whole area encompassed by the coil SP₁. The phase position φI₂ of the current I₂ flowing through the coil SP₂ is selected such that a magnetic flux B_{SP2} with a phase position φB_{SP2} of 180° is established in the whole area encompassed by the coil SP₂. The phase position φI₃ of the current I₃ flowing through the coil SP₃ is selected such that a magnetic flux B_{SP3} with a phase position φB_{SP3} of 90° is established in the whole area encompassed by the coil SP₃. The phase position φI₄ of the current I₄ flowing through the coil SP₄ is selected such that a magnetic flux B_{SP4} with a phase position φB_{SP4} of 270° is established in the whole area encompassed by the coil SP₄.

Due to the fact that the split pair coils SP_{P1} and SP_{P2} are turned 90° in relation to each other and arranged above each other, the resulting phase positions φB₁₋₄ of 315°, 45°, 135° and 225° are produced for the resulting magnetic flux densities B₁₋₄ in the coil regions BE_{P1}, BE_{P2}, BE_{P3}, BE_{P4}.

A secondary-side coil assembly A₂ also having four coil regions BE_{S1-4}, which is shown on the right in FIG. 2, can interact with the above primary-side coil assembly A₁ according to FIG. 3, wherein the secondary coil assembly can be designed identical to the primary coil assembly A₁. In the event of load and horizontal positioning of both coil assemblies A₁ and A₂ in relation to each other that is not ideal, the phase positions can move coil currents in the coils of the secondary-side coil assembly A₂ compared with the values indicated in the figure.

FIGS. 4 and 5 show primary coil assembly A₁, which can be configured identical to the primary coil arrangement A₁ shown in FIG. 3, interacting with a secondary coil assembly A₂ consisting of two rectangular coils SS₁ and SS₂, which are push-pull operated. The coils SS₁ and SS₂ are formed such that they are spatially superimposed on the size and shape of two adjacent primary-side coil regions BE_{P1}, BE_{P2} and BE_{P3}, BE_{P4}. For optimum energy transfer, the magnetic fluxes Bᵢ in the primary coil regions BE_{P1}, BE_{P2}, BE_{P3}, BE_{P4}, which correspond respectively to a secondary-side coil SS₁, SS₂, must have the same phase position φB.

In the arrangement of the secondary coil assembly A₂ relative to the primary-side coil assembly A₁ shown in FIG. 4 the coil regions BE_{P1} and BE_{P2} correspond to the coil SS1 and the coil regions BE_{P3} and BE_{P4} to the coil SS2. Due to the push-pull operation of the secondary-side coil regions BE_{P1} and BE_{P2}, the phase positions of the coil regions BE_{P1} and BE_{P2} in relation to the regions BE_{P3} and BE_{P4} must be selected offset by 180° and the phase positions φI₁₋₄ established or adjusted according to coil currents I_{1-4.}

In the arrangement of the secondary coil assembly A₂ relative to the primary-side coil assembly A₁ shown in FIG. 4, the coil regions BE_{P1} and BE_{P2} correspond to the coil SS1 and the coil regions BE_{P3} and BE_{P4} to the coil SS₂. Due to the push-pull operation of the secondary-side coils SS₁ and SS₂, the phase positions of the coil regions BE_{P1} and BE_{P2} in relation to the regions BE_{P3} and BE_{P4} must be staggered by 180° and the phase positions φI₁₋₄ established or adjusted according to coil currents I₁₋₄.

FIG. 6 shows a primary coil assembly A₁ consisting of four overlapping coils SR₁₋₄. Arranged above each other, these form the coil regions BE_{P1-4}. The only difference in design compared with the embodiment shown in FIG. 3 consists in that the coils SP₁₋₄ are not configured as rectangular, but as semi-circular.

FIG. 7 shows a primary coil assembly Aₗ consisting of four overlapping coils SP₁₋₄. Arranged above each other, these form the coil regions BE₁₋₄. The only difference in design compared with the embodiment shown in FIG. 3 consists in that the coils SP₁₋₄ are not configured as rectangular, but as triangular. Unlike the embodiment described above, the coordinate system with its quadrants I to IV is tipped at an angle of 45° as shown by the dotted line on the right in FIG. 7.

FIG. 8 shows a special shape of a primary coil assembly A₁ consisting of two coils SP₁ and SP₂ shaped in a figure of eight, which respectively form two rectangular coil regions BE_{P1}, BE_{P2} and BE_{P3}, BE_{P4} arranged at right angles to each other thus forming four abutting coil regions. By means of the type of winding in coils SP₁ and SP₂, the phase positions φB of the coil regions BE_{P1}, BE_{P3} and BE_{P2}, BE_{P4} formed by one coil are phase-moved in relation to each other by 180°. A phase shift φI of the coil currents I₁ and I₂ in relation to each other of 90° establishes the phase positions φB of 45°, 135°, 225° and 315° for the magnetic flux densities B1-4 in the four coil regions BE_{P1}, BE_{P2}, BE_{P3} and BE_{P4}.

FIG. 9 shows an inductive energy transfer device with a primary-side and a secondary-side coil assembly A₁, A₂. The planar windings form the coils of the coil assemblies A₁, A₂ together with the ferrite plates F₁, F₂. The primary-side coils SP₁₋₄ are configured as rectangular and arranged in relation to each other according to the embodiment shown and described in FIG. 3, and consequently together they form the coil regions BE_{P1}, BE_{P2}, BE_{P3} and BE_{P4}. The coil connections AN₂ of the secondary coil assembly are led upwards through an opening in the centre of the ferrite plate.

FIG. 10 shows a possible embodiment of the primary coil assembly A₁ as a solenoid. The coil assembly A₁ has a ferrite plate FE, narrow front sides F_{a-d}, as well as a flat top side F_{O} and a flat bottom side F_{U}. Windings W₁, W₂ are wound around the ferrite plate FE and arranged at right angles to each other crossing on the top side F_{O} in the centre K of the ferrite plate FE.

The windings W₁, W₂ form the coils SP_{1,2}. The arms WS₁₁, WS₁₂, WS₂₁, WS₂₂ of the windings W₁ and W₂ span the coil regions BE_{P1}, BE_{P2}, BE_{P3} and BE_{P4}. By means of corresponding phase positions of the currents in the windings W₁, W₂ and SP_{1,2} respectively, the phase positions φB can be established for the magnetic flux densities B₁₋₄ in the coil regions BE_{P1}, BE_{P2}, BE_{P3} and BE_{P4} as in the previously described embodiments.

FIG. 11 shows a primary coil assembly according to FIG. 9 with a secondary solenoid coil assembly A₂. Due to the coils SS₁ and SS₂ being arranged at right angles to each other, the secondary solenoid coil assembly A₂ has four coil regions BE_{S1}, BE_{S2}, BE_{S3} and BE_{S4}, which interact with the primary-side coil regions BE_{P1}, BE_{P2}, BE_{P3} and BE_{P4}.

FIG. 12 shows the setup of the primary-side assembly A₁, which is supplied by two controlled bridge inverters 1. The coils SP₁ and SP₂ are connected in series to resonant circuit capacitors C_{P1} and C_{P2} and together with these form the resonant circuit RES_{P}. The coil currents I₁ and I₂ are established by means of the switches T1-4. The coils SP₃ and SP₄ are also connected in series to resonant circuits C_{P3} and C_{P4} and together with these form further resonant circuits RES_{P}. The coil currents I₃ and I₄ are established by means of the switches T1-4.

A central impedance LPM is connected with one terminal to the point of connection

VP and with the other terminal to the centre tap MTP of the capacitive potential divider C_{GL1}, C_{GL2}.

FIG. 13 shows a setup of the secondary-side assembly A₂. The coils SS₁ and SS₂ are connected in series to resonant circuit capacitors C_{S1} and C_{S2} and together with these form the resonant circuit RES_{S}. Both resonant circuits are connected in series to each other and are connected to the alternating voltage connection of the first bridge inverter 2. The output-side smoothing capacitors C_{GL1}, C_{GL2} form a capacitive potential divider. The coils SS₃ and SS₄ are also connected in series to resonant circuit capacitors C_{S3} and C_{S4} and together with these form further resonant circuits RES_{S}. Both resonant circuits RES_{S} are also connected in series to each other and are connected to the alternating voltage connection of the second bridge inverter 2. The output-side smoothing capacitors C_{GL1}, C_{GL2} also form a capacitive potential divider. By means of the additional impedance L_{SM}, there is an automatic adjustment of the resonance frequencies of the resonant circuits RES_{S} to the system frequency provided a change occurs in the overall impedance of the secondary-side resonant circuits due to a horizontal offsetting of the coil assemblies A₁, A₂ from the optimum position. The additional impedances are thus connected with their first terminal to the point of connection of the coils SS₁ and SS₂, and SS₃ and SS₄ respectively, and with their second terminal to the central tap of the capacitive potential divider C_{GL1}, C_{GL2}.

It goes without saying that the secondary coil assembly A₂ can be configured according to the embodiments for the primary coil assemblies described above, wherein a rectifier circuit, according to FIG. 13, for example, can be connected downstream.

1. Aprimai-side coil assembly for an inductive energy transfer system for transferring energy between a primary- and a secondary-side coil assembly, the primary-side coil assembly comprising:
coils configured to form four adjacent coil regions of the coil assembly, wherein phase positions of respective coil currents flowing through the respective coils in relation to each other determines respective phase positions of respective magnetic flux densities in the regions wherein when using a secondary-side coil assembly with four adjacent secondary-side coil regions, the phase positions of the respective coil currents are established such that in the four adjacent coil regions of the primary-side coil assembly, the respective phase positions of the respective magnetic flux densities are 0°, 90°, 180° and 270° in relation to each other.

2. The primary-side coil assembly according to claim 1, wherein the phase positions of the respective coil currents of the primary-side coil assembly are 0°, 90°, 180° and 270° in relation to each other when using four coils, and when using two diagonally offset coils are 180° in relation to each other.

3. The primary-side coil assembly according to claim 1, assembly with two adjacent planar coil regions, two primary-side coil regions are assigned to a respective secondary-side coil region, and the phase positions of the magnetic flux densities that are established in the respective primary-side coil regions assigned to one secondary-side coil region are 0° in relation to each other, and wherein the phase positions of the magnetic flux densities that are established in the respective primary-side coil regions assigned to a different secondary-side coil regions are 180° in relation to each other.

4. The primary-side coil assembly according to claim 3, wherein the phase position of the coil currents between two split pair coils is 180° and the phase position of the coil currents between the coils of each split pair coil is 0° respectively.

5. The primary-side coil assembly according to the claims 1, wherein the phase positions of the magnetic flux densities that are established in the regions are is 0° (zero degrees) in relation to each other.

6. The primary-side coil assembly according to claim 5, wherein the phase positions of the coil currents of the primary-side coil assembly are is 0° (zero degrees) in relation to each other when using a secondary-side circular coil assembly with a coil region.

7. The primary-side coil assembly for an inductive energy transfer system according to claim 1, further comprising a control device configured to detect a type of the secondary-side coil assembly and, based on the type of the secondary-side coil assembly, to establish the phase positions of the coil currents in relation to each other.

8. The primary-side coil assembly for an inductive energy transfer system according to claim 1, wherein the primary-side coil assembly is formed from four coils, wherein one coil overlaps with at least two other coils and with these forms two spatially adjacently arranged coil regions.

9. The primary-side coil assembly for an inductive energy transfer system according to claim 1, wherein each of the four coil regions is arranged in a quadrant, wherein the coil regions have a square, rectangular, triangular or part-circle shaped outline contour.

10. The primary-side coil assembly for an inductive energy transfer system according to claim 1, wherein each coil covers or encompasses just one or two coil regions.

11. The primary-side coil assembly for an inductive energy transfer system according to claim 1, wherein each coil covers two adjacent coil regions or two coil regions arranged diagonally to each other.

12. The primary-side coil assembly for an inductive energy transfer system according to claim 1, wherein the coils comprise four coils, wherein the four coils are configured as rectangular, wherein respective pairs of two coils form split pair coils, and wherein the split pair coils are turned 90° in relation to each other and arranged above each other.

13. The primary-side coil assembly for an inductive energy transfer system according to claim 12, wherein if a secondary-side coil assembly comprising four adjacent coil regions is used, the phase positions of the coil currents of the coils of a first split pair coil are 0° and 180°, and the phase positions of the coil currents of the coils of a second split pair coil are 90° and 270°.

14. The primary-side coil assembly for an inductive energy transfer system according to claim 1, wherein the coil assemblies have a rectangular round, or elliptical outline contour.

15. The primary-side coil assembly for an inductive energy transfer system according to claim 1, wherein the primary-side coil assembly, in addition to four coils further comprises at least one further coil arranged so as to overlap with at least one of the coil regions.

16. The primary-side coil assembly for an inductive energy transfer system according to claim 1, wherein each of the coils forms a resonant circuit with at least one capacitor, and wherein the individual resonant circuits are supplied by at least one controlled inverter.

17. The primary-side coil assembly for an inductive energy transfer system according to claim 16, wherein the respective coils are connected in series to a split pair coil wherein a centre tap impedance is electrically connected by one terminal to a point of connection of both coils connected in series and by another terminal to a midpoint/centre tap, positive or negative terminal of an intermediate circuit of the inverter.

18. The primary-side coil assembly for an inductive energy transfer system according to claim 1, wherein the coils are planar coils.

19. The primary-side coil assembly for an inductive energy transfer system according to claim 1, wherein respective pairs of the coils form split pair coils, and wherein the coils forming a respective split pair coil are formed by a single winding with a centre tap.

20. The primary-side coil assembly for an inductive energy transfer system according to claim 1, wherein the coils are wound around a ferrite plate, wherein respective ones of the coils: (1) are arranged at right angles to each other at least on a flat side of the ferrite plate; or (2) cross at least on the flat side of the ferrite plate, in a centre thereof; or both (1) and (2).

21. The primary-side coil assembly according to claim 20, wherein the primary-side coil assembly is a solenoid assembly, wherein the coils are formed by windings, which rest against flat sides and on narrow front sides of the ferrite plate.

22. The primary-side coil assembly according to claim 21, wherein the windings are supplied by means of inverters.

23. The primary-side coil assembly according to claim 20, wherein arms of windings together divide the ferrite plate (FE) into regions from a crossing point, which regions form the coil regions.

24. An inductive energy transfer system for transferring energy between a primary-side coil assembly and a secondary-side coil assembly, wherein the primary-side coil assembly comprises the primary-side coil assembly according to claim 1.

25. The inductive energy transfer system according to claim 24, wherein the secondary coil assembly comprises a circular coil assembly, a coil assembly with two adjacent planar coils or a coil assembly corresponding to the primary-side coil assembly.
